(19) United States
(12) Patent Application Publication
(10) Pub. No.: US 2006/0294022 A1
(43) Pub. Date: Dec. 28, 2006

(54) Apparatus, system, and method for enabling a service

(76) Inventors: Richard Alan Dayan, Raleigh, NC (US); Jeffrey Bart Jennings, Raleigh, NC (US); Rohith A. Parasuraman, Durham, NC (US)

Correspondence Address: KUNZLER & ASSOCIATES, 8 EAST BROADWAY, SUITE 600, SALT LAKE CITY, UT, 84111, US

(21) Appl. No.: 11/158,418

(22) Filed: Jun. 22, 2005

(51) Int. Cl. H04L 9/00

(52) U.S. Cl. 705/65

(57) ABSTRACT

An apparatus, system, and method are disclosed for enabling a service. A receiving module receives a token communicated over a peer-to-peer network. An enablement module enables a service in response to an authorization data field of the token. A transmit module transmits the token over the peer-to-peer network. The apparatus, system, and method may strive to enable the service.

### BACKGROUND OF THE INVENTION

1. Field of the Invention

This invention relates to enabling a service and more particularly relates to enabling a service using a token transmitted between data processing devices over a peer-to-peer network.

2. Description of the Related Art

A data processing device (“DPD”) typically executes a variety of software programs. Many software programs are licensed from a vendor. An organization may acquire an image of a software program and one or more licenses for the software program in order to use the software program. The organization often makes the software program image available to a plurality of DPDs within the organization over a network. The DPDs may execute the software program from a central storage device or download and execute a copy of the software program image. Thus the software program image is easily proliferated within the organization.

The vendor typically requires that each DPD executing the software program have a license for the software program. For example, the vendor may sell the organization twenty-five (25) licenses, each license allowing a DPD to execute the software program. The contract between the vendor and the organization typically requires the organization to only allow DPD with a valid license to execute the software program.

Unfortunately, because the software program image is easily accessible within the organization, more DPDs than allowed by the license may execute the software program, depriving the vendor of revenue and exposing the organization to potential liability. Organizations therefore often track the licensing of software programs to assure compliance with vendor agreements.

Unfortunately, tracking and managing the distribution of licenses for a plurality of software programs executing on a plurality of DPD can be a large administrative burden. In addition, the time required to request a license, have the license approved and recorded, and issue the license to a DPD can adversely affect the productivity of a DPD or the DPD user by substantially delaying use of the software program.

In addition to licenses, a vendor may wish to distribute other services to DPDs over an organization's network. For example, the vendor may desire to distribute software program upgrades, short-term licenses, data base access licenses, and the like to DPDs over the network. Unfortunately, the distribution of such services may be expensive because of the difficulties of accounting for distributions of the authorizations.

From the foregoing discussion, it should be apparent that a need exists for an apparatus, system, and method that enable a service over a network. Beneficially, such an apparatus, system, and method would strive to be enabled from the DPD and simplify the administration of service authorization accounting within an organization.

### SUMMARY OF THE INVENTION

The present invention has been developed in response to the present state of the art, and in particular, in response to the problems and needs in the art that have not yet been fully solved by currently available service enabling methods. Accordingly, the present invention has been developed to provide an apparatus, system, and method for enabling a service that overcome many or all of the above-discussed shortcomings in the art.

The apparatus to enable a service is provided with a logic unit containing a plurality of modules configured to functionally execute the necessary steps of receiving a token, enabling a service, and transmitting the token. These modules in the described embodiments include a receiving module, an enablement module, and a transmit module. The apparatus may also include a modification module.

The receiving module receives a token over a peer-to-peer network. The token is configured to direct the enabling of a service and includes one or more data fields including one or more fields configured as an authorization data field. The authorization data field authorizes the enabling of the service. For example, the authorization field may be an available services field that specifies the number of service authorizations available wherein the service may be enabled if at least one service authorization is available.

The token may also include a services in use field that specifies the number of services that have been enabling on one or more DPDs by the token. In one embodiment, the token includes a capacity on demand field that indicates that the token should enable the service even if the available services field specifies that no service authorizations are available. In a certain embodiment, the token includes an obtain additional service field that directs an administrator to obtain one or more additional service authorizations.

The service may be a software license, a software upgrade, a temporary license, access to a data base or the like. For example, the token may enable the service by granting a software program license to the DPD. The token may also enable the service by upgrading the license. In a certain embodiment, the token may enable a service by revoking the license.

The enablement module enables the service responsive to the token. For example, the enablement module may enable the execution of a software program image in response to the token. In one embodiment, the modification module modifies the token with a record of the enabled service. For example, the modification module may decrement the available services field to indicate that one fewer service authorization is available. The transmit module transmits the token over the peer-to-peer network. The apparatus enables a service for a plurality of DPDs using a single token.

A system of the present invention is also presented to enable a service. The system may be embodied a peer-to-peer network. In particular, the system, in one embodiment, includes a network, a plurality of DPDs, a receiving module, an enablement module, and a transmit module. In one embodiment, the system further includes an injection module and a notification module.

The plurality of DPDs are in communication over a network. The DPDs are organized as a peer-to-peer network. The injection module may inject a token into the peer-to-peer network. For example, the injection module may communicate the token to a first DPD over the peer-to-peer network. The first DPD may then communicate the token to a second DPD. Each DPD in the peer-to-peer network receives and transmits the token.

In one embodiment, each DPD comprises a receiving module, an enablement module, and a transmit module. The receiving module of the first DPD may receive the token. In addition, the first DPD may need to enable a service. The enablement module of the first DPD enables the service for the first DPD responsive to an authorization data field of the token. The transmit module of the first DPD transmits the token to another DPD such as the second DPD. The token may also enable the service for the second DPD. Thus the system enables the service for a plurality of DPDs with a single token.

In one embodiment, the notification module notifies an administrator to obtain an additional service authorization. The notification module may directly notify the administrator. In a certain embodiment, the notification module notifies the administrator by modifying the token to include a notification and the administrator receives the token over the peer-to-peer network. Thus the system may improve the efficiency of obtaining sufficient service authorizations for the organization.

A method of the present invention is also presented for enabling a service. The method in the disclosed embodiments substantially includes the steps necessary to carry out the functions presented above with respect to the operation of the described apparatus and system. In one embodiment, the method includes receiving a token, enabling a service, and transmitting the token. The method also may include notifying an administrator to obtain an additional service authorization.

A receiving module receives a token communicated over a peer-to-peer network. An enablement module enables a service in response to an authorization data field of the token. In one embodiment, the authorization data field is an available services field that specifies the number of service authorizations that are available. In an alternate embodiment, the authorization data field is a capacity on demand field that directs the enabling of the service regardless of the number of service authorizations that are available.

In one embodiment, a notification module notifies an administrator to obtain an additional service authorization. In a certain embodiment, the notification module modifies an obtain additional services data field of the token to notify the administrator. A transmit module transmits the token over the peer-to-peer network.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention enables a service for a plurality of DPDs using a token communicated over a peer-to-peer network. In addition, the present invention may notify an administrator to obtain additional service authorizations. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a peer-to-peer network system in accordance with the present invention;

FIG. 2 is a schematic block diagram illustrating one embodiment of a service enabling apparatus of the present invention;

FIG. 3 is a schematic block diagram illustrating one embodiment of a data processing device in accordance with the present invention;

FIG. 4 is a schematic flow chart diagram illustrating one embodiment of a service enabling method of the present invention;

FIG. 5 is a schematic block diagram illustrating one embodiment of a token in accordance with the present invention;

FIG. 6 is a schematic block diagram illustrating one embodiment of token injection in accordance with the present invention;

FIG. 7 is a schematic block diagram illustrating one embodiment of service enabling in accordance with the present invention; and

FIG. 8 is a schematic block diagram illustrating one embodiment of token passing in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

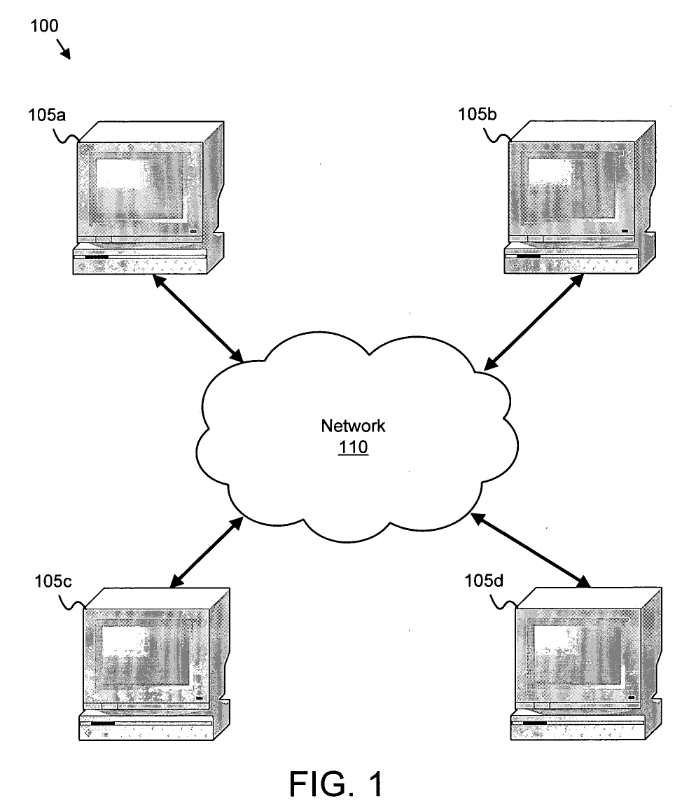

FIG. 1 is a schematic block diagram illustrating one embodiment of a peer-to-peer network system 100 in accordance with the present invention. The system 100 includes one or more DPDs 105, and a network 110.

The network 110 may be a local area network (“LAN”) such as an Ethernet network, a token ring network, or the like. For example, the network 110 may be the internal LAN of an organization. The network 110 may also comprise a plurality of LANs including LANs in mutual communication through the Internet.

The DPDs 105 are in communication over the network 110. In addition, the DPDs 105 are organized as a peer-to-peer network. Each DPD 105 may communicate over the peer-to-peer network through layered protocols wherein each DPD 105 communicates with each other DPD 105 through the same protocol layer. For example, the first DPD 105a may communicate as a peer with a second DPD 105b. In addition, there is no central or organizing device that controls the peer-to-peer network.

The DPDs 105 may exchange one or more tokens. A token may comprise one or more data fields. A DPD 105 receives the token by reading the data fields of the token from a communication port in communication with the network 110 and storing the data fields in memory. The DPD 105 further transmits the token by writing the data fields of the token to a communication port wherein the communication port communicates the token data fields to the network 110.

In one embodiment, each DPD 105 is configured to employ a service. The service may be a software program stored as a software program image, access to a data base, or the like. A DPD 105 may employ the service if the service is enabled for the DPD 105. For example, the first DPD 105 may only access the commercial data base if the commercial data base service is enabled such as by granting the first DPD 105 a license to access the data base.

In the past, the DPD 105 or a DPD 105 user would request that the service be enabled. For example, the DPD 105 may request that an administrator enable the service. The administrator typically purchased one or more service authorizations such as licenses or the like. The administrator received service authorization requests, issued service authorizations, tracked the service authorizations issued, and otherwise managed the enabling of services.

Unfortunately, managing the enabling a plurality of services for many DPDs can be complex and expensive. In addition, the process of requesting and receiving service authorizations can be time-consuming. As a result, a user or a DPD 105 may be delayed in employing a needed service. For example, the DPD 105 may be unable to execute a software program image until the service is enabled for the DPD 105. The user may also be required to take one or more actions to enable the service, increasing the inconvenience of enabling the service.

The present invention may allow a service to strive to be enabled. In addition, the present invention supports enabling the service with a token communicated between DPDs 105 over the peer-to-peer network.

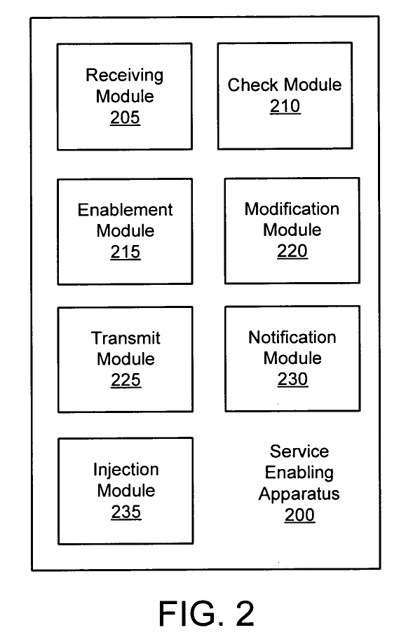

FIG. 2 is a schematic block diagram illustrating one embodiment of a service enabling apparatus 200 of the present invention. The apparatus 200 may be comprised by a DPD 105 of FIG. 1. In one embodiment, each DPD 105 of FIG. 1 comprises the apparatus 200. The apparatus 200 as depicted includes a receiving module 205, a check module 210, an enablement module 215, a modification module 220, a transmit module 225, a notification module 230, and an injection module 235.

The receiving module 205 receives a token over a peer-to-peer network such as the peer-to-peer network of FIG. 1. In one embodiment, the receiving module 205 receives the token a plurality of instances. For example, a first DPD 105a may receive and transmit the token, and subsequently again receive the token. Each DPD 105 in the peer-to-peer network may be configured to communicate the token to another DPD 105 in a manner such that all DPDs 105 receive the token. For example, each DPD 105 may communicate the token to a specified other DPD 105. In an alternate example, each DPD 105 may random communicate the token to another DPD 105. Each DPD 105 only communicates the token to one other DPD 105. Thus a single token is exchanged among the DPDs 105.

The token includes one or more data fields. One or more fields are configured as an authorization data field. The authorization data field authorizes the enabling of the service. In one embodiment, the authorization data field may be an available services field. The available services field specifies the number of service authorizations available for enabling the service. For example, if the value of the available services field is five (5), the token may enable the service for five (5) DPDs. The token may enable the service if at least one service is available as indicated by the available services field.

In an alternate embodiment, the authorization data field is a capacity on demand field. The capacity on demand field may direct the enabling of the service regardless of the number of service authorizations that are available. In a certain embodiment, the authorization data field comprises both the available services field and the capacity on demand field.

The service may be a software license, a software upgrade, a temporary license, or the like. For example, the token may authorize the enabling of the software program service by granting a license to the DPD 105 to execute the software program image. The token may also enable the service by upgrading the license of the DPD 105. In a certain embodiment, the token may enable a service by revoking the license.

In one embodiment, the check module 210 determines that at least one service authorization is available. The check module 210 checks the authorization data field to determine that at least one service authorization is available. In one embodiment, the check module 210 checks the available services field. For example, the check module 210 may read the value five (5) from the available services field and determine that at least one service authorization is available. In an alternate embodiment, the check module 210 checks the capacity on demand field and determines a service authorization is available if the value of the capacity on demand field indicates the authorization always available. For example, the capacity on demand field may have a binary one (1b) value, indicating that the capacity on demand field is asserted and the service authorization is always available.

The enablement module 215 enables the service responsive to the token. In one embodiment, the enablement module 215 enables the service if at least one service authorization is available. For example, the enablement module 215 may enable the execution of a software program image in response to the available services field of the token containing a data value of one (1) or greater.

In an alternate embodiment, the enablement module 215 enables the service if the capacity on demand field is asserted. The enablement module 215 may enable the service if the capacity on demand field is asserted even if the available services field contains a value indicating that no service authorizations are available, such a zero (0) value. For example, the enablement module 215 may retrieve an access code for a data base, enabling a DPD 105 user to access the data base in response to the capacity on demand field having an asserted value.

In one embodiment, the modification module 220 modifies the token with a record of the enabled service. For example, if the enablement module 215 enables the service in response to the available services field containing the value five (5), the modification module 220 may decrement the available services field to indicate that one fewer service is available for authorization and write the value four (4) to the available services field.

In one embodiment, the notification module 230 notifies an administrator to obtain an additional service authorization. The notification module 230 may notify the administrator if the enablement module 215 did not enable the service. In an alternate embodiment, the notification module 230 may notify administrator when the available service authorizations indicated by the available services field are less than a threshold value. For example, the notification module 230 may notify the administrator if three (3) or fewer service authorizations are available.

The notification module 230 may directly notify with the administrator. For example, the token may include an administrator Internet protocol (“IP”) address or LAN address and the notification module 230 may communicate the notification to the administrator at the IP address or LAN address. In an alternate example, the token may include an administrator email address and the notification module 230 may communicate an email message to the administrator notifying the administrator to obtain one or more additional service authorizations.

In one embodiment, the notification module 230 notifies the administrator by modifying the token to include a notification. The administrator may be a peer on the peer-to-peer network such as a DPD 105 of FIG. 1 and receive the token as the token is exchanged among the peers of the peer-to-peer network. The notification module 230 may also direct the transmission of the token directly to the administrator.

Upon receiving the notification from the notification module 230, the administrator may obtain one or more additional service authorizations. For example, the administrator may purchase an additional twenty-five (25) service authorization licenses for a software program. The administrator modifies the token to indicate the availability of additional service authorizations. For example, the administrator may increment the available services field of the token to indicate the availability of the additional twenty-five service authorizations. If the notification module 230 directed the communication of the token to the administrator, the administrator may hold the token until the additional service authorization is obtained. The administrator may also modify the token subsequent to both obtaining the additional service authorization and receiving the token over the peer-to-peer network.

The transmit module 225 transmits the token over the peer-to-peer network. In one embodiment, transmit module 225 transmits the token according to a protocol for exchanging tokens over the peer-to-peer network. For example, a first DPD 105a may transmit the token to a specified second DPD 105b. In an alternate example, the first DPD 105a may transmit token to a randomly selected DPD 105 such as by selecting a LAN address from a list of LAN addresses for peer-to-peer network peers.

In one embodiment, the injection module 235 injects the token into the peer-to-peer network. An administrator's DPD 105 may comprise the injection module 235. Alternatively, a first DPD 105a may obtain a token for a service such as access to a web-based software program. The injection module 235 of the first DPD 105a may inject the token into the peer-to-peer network to make the web-based software program available to other DPDs 105. The apparatus 200 enables a service for a plurality of DPDs 105 using a single token.

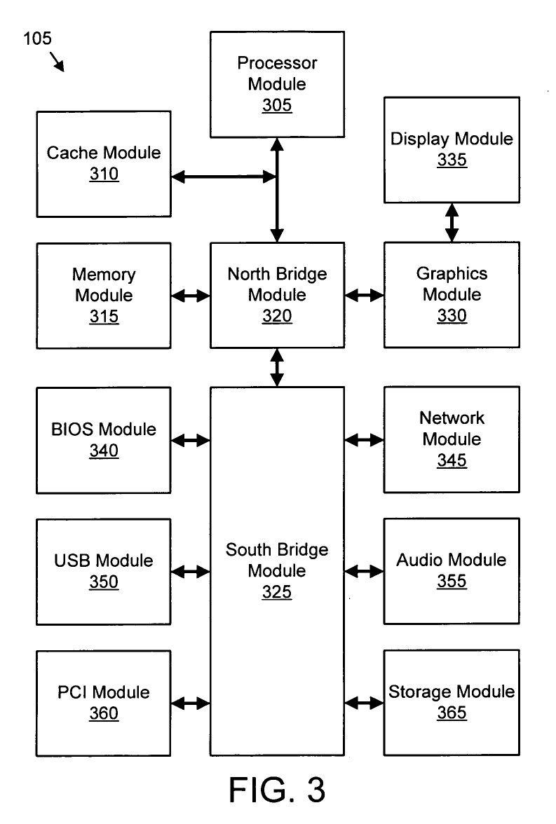

FIG. 3 is a schematic block diagram illustrating one embodiment of a DPD 105 in accordance with the present invention. As depicted, the DPD 105 may be the DPD 105 of FIG. 1. The DPD 105 includes a processor module 305, a cache module 310, a memory module 315, a north bridge module 320, a south bridge module 325, a graphics module 330, a display module 335, a basic input/output system (“BIOS”) module 340, a network module 345, a universal serial bus (“USB”) module 350, an audio module 355, a peripheral component interconnect (“PCI”) module 360, and a storage module 365.

The processor module 305, cache module 310, memory module 315, north bridge module 320, south bridge module 325, graphics module 330, display module 335, BIOS module 340, network module 345, USB module 350, audio module 355, PCI module 360, and storage module 365, referred to herein as components, may be fabricated of semiconductor gates on one or more semiconductor substrates. Each semiconductor substrate may be packaged in one or more semiconductor devices mounted on circuit cards. Connections between components may be through semiconductor metal layers, substrate to substrate wiring, or circuit card traces or wires connecting the semiconductor devices.

The memory module 315 stores software instructions and data. The processor module 305 executes the software instructions and manipulates the data as is well known to those skilled in the art. In one embodiment, the memory module 315 stores and the processor module 305 executes software instructions and data comprising the receiving module 205, the check module 210, the enablement module 215, the modification module 220, the transmit module 225, the notification module 230, and the injection module 235 of FIG. 2.

The processor module 305 communicates with other DPDs 105 such as the DPDs of FIG. 1 through the north bridge module 320, the south bridge module 325, and the network module 345. The network module 345 may contain one or more communications ports in communication with a network 110 such as the network of FIG. 1. In one embodiment, the processor module 305 receives a token through network module 345, the south bridge module 325, and the north bridge module 320. The processor module 305 may store the data fields comprising the token in the memory module 315.

In addition, the processor module 305 may enable a service in response to the token. For example, the processor module 305 may write a data value to a data field in a software program image indicating that the processor module 305 is authorized to execute the software program. The processor module 305 may also modify the token by writing a data value to one or more token data fields locations in the memory module 315. In addition, the processor module 305 may transmit the token by writing the data fields of the token stored in the memory module 315 to the network module 345. The network module 345 may communicate the token data fields to another DPD 105.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

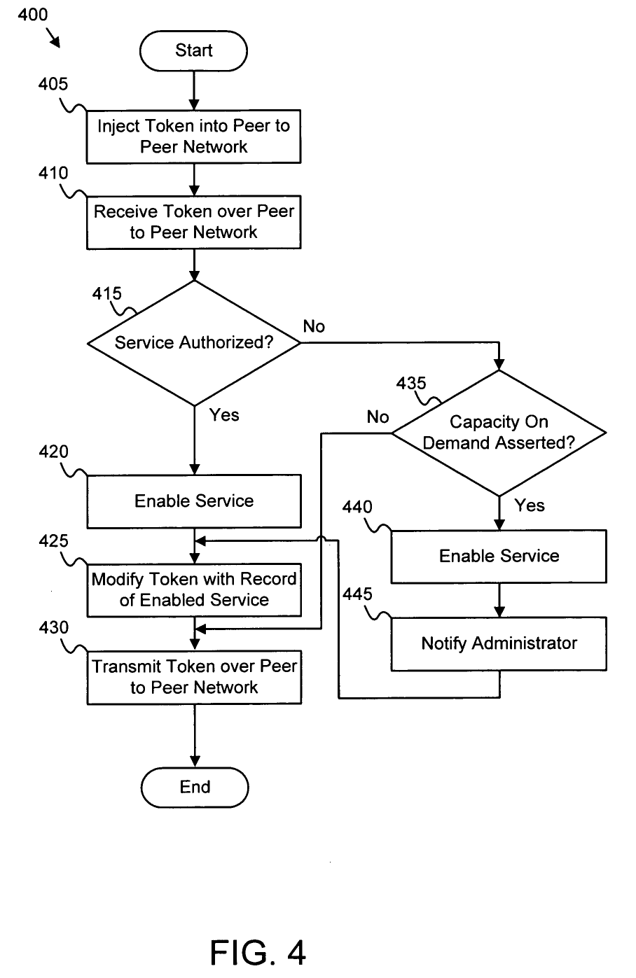

FIG. 4 is a schematic flow chart diagram illustrating one embodiment of a service enabling method 400 of the present invention. The method 400 begins and an injection module 235 injects 405 a token into a peer-to-peer network. The injection module 235 may be the injection module 235 of FIG. 2 and the peer-to-peer network may comprise the DPDs 105 and network 110 of FIG. 1.

In one embodiment, the injection module 235 is comprised by an administrator's DPD 105. For example, the administrator may purchase ten (10) licenses for access to a commercial data base. The supplier of the commercial data base may communicate the injection module 235 to the administrator's DPD 105. The injection module 235 may create the token and write the value ten (10) to the available services field of the token. The injection module 235 may then communicate the token to a DPD 105 of the peer-to-peer network. In an alternate embodiment, the injection module 235 is any DPD 105 on a peer-to-peer network that enables a service such as a software program.

A receiving module 205 receives 410 the token over the peer-to-peer network. In one embodiment, the token is directed to a specified communication port address. The receiving module 205 may be monitoring or listening for the token at the port address. For example, an installer software process configured to install a software program on a DPD 105 may spawn the receiving module 205 as a process to execute on the DPD 105. The receiving module 205 may listen at logical port ‘7Fx’ where ‘7Fx’ is a hexadecimal address. When the token is communicated to the DPD 105, the receiving module 205 receives 410 the token.

In one embodiment, a check module 210 determines 415 if a service is authorized by the token. The check module 210 may read a data value from an authorization data field to determine if the service is authorized. In a certain embodiment, the check module 210 reads an available services data field and determines 415 the service is authorized if the available services data field contains a value of one (1) or greater, indicating that at least one service authorization is available. If the available services data field contains a value of zero (0) or less, the check module 210 may determine 415 that the service is not authorized.

In one embodiment, if the check module 210 determines 415 the service is authorized, an enablement module 215 enables 420 a service. In one embodiment, the enablement module 215 writes a decryption key to a file to enable the service. The decryption key may be a value that is used in a mathematical equation to decrypt a plurality of data values as is well known to those skilled in the art. In an alternate embodiment, the enablement module 215 writes an authorization value to a file to enable 420 the service.

In one embodiment, a modification module 220 modifies 425 the token with a record of the enabled service. In a certain embodiment, the modification module 220 decrements the token's available services field value. For example, if the available services field contained the value of nine (9) prior to the enablement module 215 enabling 420 the service, the modification module 220 may write the value of eight (8) to the available services field.

In one embodiment, the modification module 220 increments a services in use data field of the token. For example, if the services in use data field contained the value of twenty-two (22) prior to the enablement module 215 enabling 420 the service, the modification module 220 may write the value of twenty-three (23) to the services in use data field. In a certain embodiment, the modification module 220 appends an identifier such as an identification number of the DPD 105 for which the service was enabled to the token.

In one embodiment, if the check module 210 determines 415 the service not is authorized, the check module 210 determines 435 if the capacity on demand data field is asserted. The capacity on demand data field may be a binary bit of a data field. If the capacity on demand data field is a specified data value such as a binary one (1), the check module 210 may determine 435 the capacity on demand data field is asserted.

If the check module 210 determines 435 the capacity on demand data field is asserted, the enablement module 215 may enable 440 the service. In one embodiment, a notification module 230 notifies 445 an administrator to obtain an additional service authorization. The notification module 230 may modify an obtain additional service data field of the token such as by writing a specified value to the obtain additional service data field. The administrator obtains one or more addition service authorizations in response to receiving the token and reading the obtain additional services data field value.

If the check module 210 determines 435 the capacity on demand data field is not asserted and/or the modification module 425 has modified the token, the transmit module 225 transmits 430 the token over the peer-to-peer network such as to a second DPD 105b and the method 400 ends. The transmitted token may enable the service on the second DPD 105b. The method 400 allows the token to enable services for a plurality of DPDs 105. In one embodiment, the method 400 is repeated as an endless loop on each DPD 105 of the peer-to-peer network.

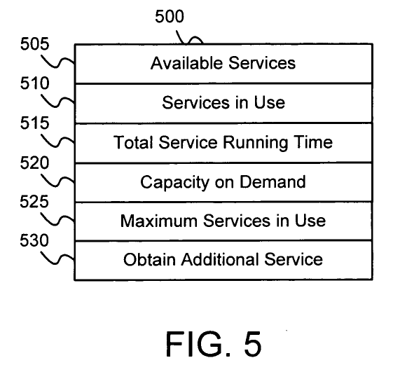

FIG. 5 is a schematic block diagram illustrating one embodiment of a token 500 in accordance with the present invention. The token 500 may be the token 500 exchanged between DPDs 105 as described in FIGS. 1-4. As depicted, the token 500 includes an available services field 505, a services in use field 510, a total services running time field 515, a capacity on demand field 520, a maximum services in use field 525, and an obtain additional service field 530.

The available services field 505 may contain a value specifying the number of DPDs 105 for which the token may enable 420 service. The check module 210 may read the available services field 505 to determine 415 if the service may be authorized for a DPD 105. The modification module 220 may also modify 425 the available services field 505 by decrementing the available services field 505 value such as after the service is enabled. In a certain embodiment, an administrator may add a value equivalent to the number of service authorizations obtained to the available services field 505. For example, the administrator may obtain fifteen (15) service authorization licenses and add fifteen to the available services field 505 value.

In one embodiment, the services in use field 510 specifies the number of services that have been enabling on one or more DPDs 105 by the token 500. For example, if the token 500 has enabled the service on thirty-five DPDs 105, the services in use field 510 will contain the value thirty-five (35). The modification module 220 may modify the services in use field 510 by incrementing the value of the services in use field 510 when the enablement module 215 enables 420 a service.

In one embodiment, the total service running time field 515 contains a value indicating the accumulated running time of the service on one or more DPDs 105. The modification module 220 of a first DPD 105a may accumulate the elapsed running time of the service for the first DPD 105a, sum the accumulated running time with the total service running time field 515 value, and write the sum to the total service running time field 515. The total service running time field 515 may further accumulate the running time for each DPD 105 on the peer-to-peer network that employs the service. In a like manner, the token 500 may accumulate additional statistics and parameters from the DPDs 105.

In one embodiment, the capacity on demand field 520 indicates that the token enablement module 215 should enable the service even if the available services field 505 specifies that no service authorizations are available. The obtain additional service field 525 may direct an administrator to obtain one or more additional service authorizations. In one embodiment, the obtain additional service field contains a value indicating the number of service authorizations that the administrator should obtain. In an alternate embodiment, the obtain additional service field 525 is configured as a logical value that when asserted indicates that the administrator should obtain a discretionary number of service authorizations.

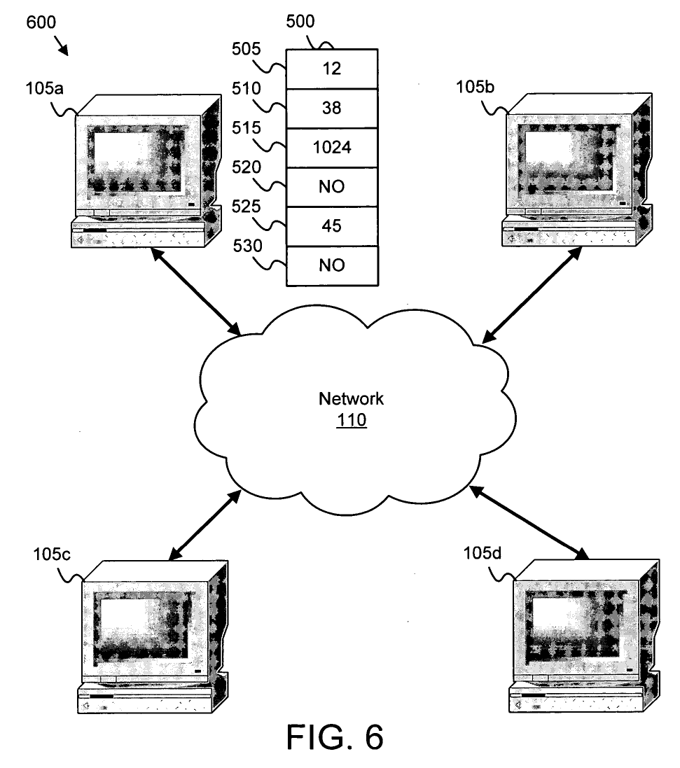

FIG. 6 is a schematic block diagram illustrating one embodiment of token injection 600 in accordance with the present invention. The depicted DPDs 105 and network 110 may be the DPDs 105 and network 110 of FIG. 1. A first DPD 105a creates a token 500. The token 500 includes an available services field 505 with a value of twelve (12), indicating the token 500 may direct the enabling of the service for twelve (12) DPDs 105. In one embodiment, the first DPD 105a is an administrator's DPD 105. In an alternate embodiment, the first DPD 105a is the initial DPD 105 to enable 420 the service.

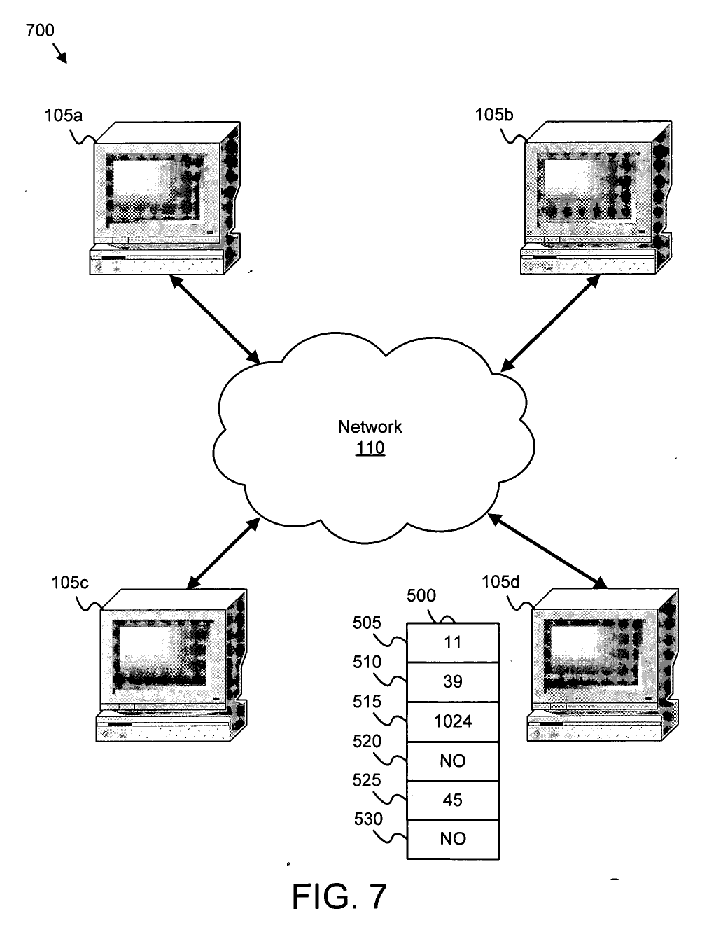

FIG. 7 is a schematic block diagram illustrating one embodiment of service enabling 700 in accordance with the present invention. As depicted, the DPDs 105, network 110, and token 500 are the DPDs 105, network 110 and token 500 of FIG. 6. The first DPD 105a injects 405 the token 500 into a peer-to-peer network over the network 110. A fourth DPD 150d receives the token 500. The check module 210 of the fourth DPD 105d determines 415 the service is authorized as the available services field 505 value is greater than zero (0). The enablement module 215 of the fourth DPD 105d enables 420 the service. In addition, the modification module 220 of the fourth DPD 105d modifies the token 500 by decrementing the available services field 505 to a value of eleven (11).

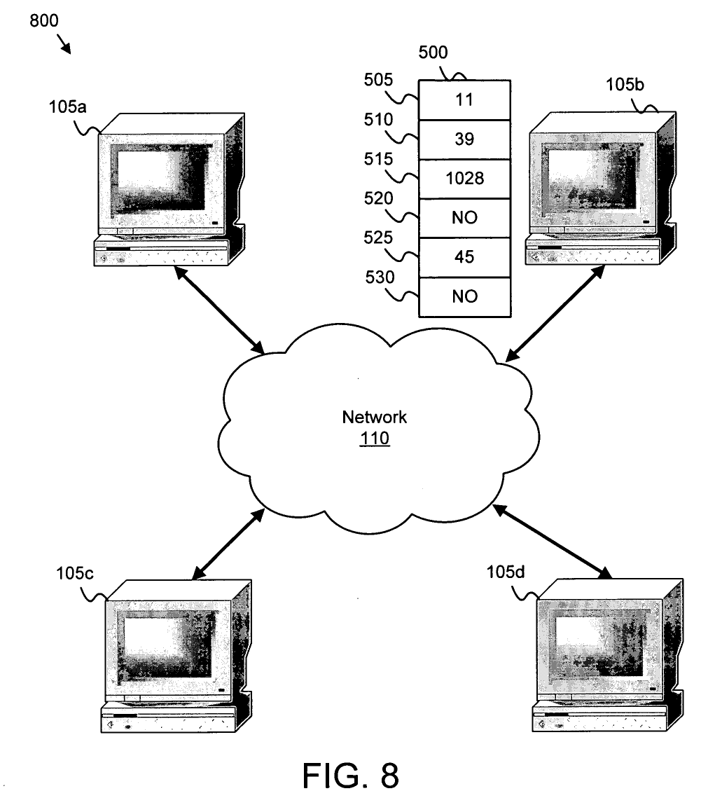

FIG. 8 is a schematic block diagram illustrating one embodiment of token passing 800 in accordance with the present invention. As depicted, the DPDs 105, network 110, and token 500 are the DPDs 105, network 110 and token 500 of FIGS. 6 and 7. The fourth DPD 105d of FIG. 7 transmits the modified token 500 of FIG. 7 to a second DPD 105b. The modified token 500 may also direct the enabling of the service for the second DPD 105b.

The present invention enables a service for a plurality of DPDs 105 using a token 500 communicated over a peer-to-peer network. In addition, the present invention may notify an administrator to obtain additional service authorizations. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to enable a service, the apparatus comprising:
a receiving module configured to receive a token communicated over a peer-to-peer network, the token enabling a service for a plurality of data processing devices in communication over the peer-to-peer network;
an enablement module configured to enable the service responsive to an authorization data field of the token; and
a transmit module configured to transmit the token over the peer-to-peer network.

2. The apparatus of claim 1, further comprising a check module configured to check that at least one service authorization is available using the authorization data field.

3. The apparatus of claim 1, the enablement module further configured to enable the service responsive to a capacity on demand field of the token.

4. The apparatus of claim 1, further comprising a notification module configured to notify an administrator to obtain an additional service authorization.

5. The apparatus of claim 1, further comprising a modification module configured to modify the token with a record of the enabled service.

6. The apparatus of claim 5, the modification module further configured to modify the token with service use data.

7. The apparatus of claim 1, wherein the service is a software license.

8. A system to enable a service, the system comprising:
a network;
a plurality of data processing devices in communication over the network and organized in a peer-to-peer network;
a receiving module configured to receive a token communicated over the peer-to-peer network, the token enabling a service for the plurality of data processing devices;
an enablement module configured to enable the service responsive to an authorization data field of the token; and
a transmit module configured to transmit the token over the peer-to-peer network.

9. The system of claim 8, further comprising a check module configured to check that at least one service authorization is available using the authorization data field.

10. The system of claim 8, further comprising a notification module configured to notify an administrator to obtain an additional service authorization.

11. The system of claim 8, further comprising a modification module configured to modify the token with a record of the enabled service.

12. The system of claim 8, further comprising an injection module configured to inject the token into the peer-to-peer network.

13. A signal bearing medium tangibly embodying a program of machine-readable instructions executable by a digital processing apparatus to perform operations to enable a service, the operations comprising:
receiving a token communicated over a peer-to-peer network and configured to enable a service for a plurality of data processing devices in communication over the peer-to-peer network;
enabling the service responsive to an authorization data field of the token; and
transmitting the token over the peer-to-peer network.

14. The signal bearing medium of claim 13, wherein the instructions further comprise an operation to check that at least one service authorization is available using the authorization data field.

15. The signal bearing medium of claim 13, wherein the instructions further comprise an operation to enable the service responsive to a capacity on demand field of the token.

16. The signal bearing medium of claim 13, wherein the instructions further comprise an operation to notify an administrator to obtain an additional service authorization.

17. The signal bearing medium of claim 13, wherein the instructions further comprise an operation to modify the token with a record of the enabled service.

18. The signal bearing medium of claim 13, wherein the instructions further comprise an operation to modify the token with service use data.

19. The signal bearing medium of claim 13, wherein the instructions further comprise an operation to inject the token into the peer-to-peer network.

20. The signal bearing medium of claim 13, wherein the service is a software license.

21. The signal bearing medium of claim 13, wherein the service is a software upgrade.

22. The signal bearing medium of claim 13, wherein the authorization data field is encrypted.

23. A method for deploying computer infrastructure, comprising integrating computer-readable code into a computing system, wherein the code in combination with the computing system is capable of performing the following:
receiving a token communicated over a peer-to-peer network and configured to enable a service for a plurality of data processing devices in communication over the peer-to-peer network;
enabling the service responsive to an authorization data field of the token; and
transmitting the token over the peer-to-peer network.

24. The method of claim 23, further comprising modifying the token with a record of the enabled service.

25. An apparatus to enable a service, the apparatus comprising:
means for receiving a token communicated over a peer-to-peer network and configured to enable a service for a plurality of data processing devices in communication over the peer-to-peer network;
means for checking that at least one service authorization is available using an authorization data field of the token.
means for enabling the service responsive to the authorization data field; and
means for transmitting the token over the peer-to-peer network.
